(19) United States
(12) Patent Application Publication
(10) Pub. No.: US 2001/0032751 A1
(43) Pub. Date: Oct. 25, 2001

(54) Hydraulic steering arrangement

(76) Inventors: Svend Giversen, Sonderborg (DK); Johan van Beek, Sonderborg (DK); Lars Mortensen, Augustenborg (DK); Ole Vincentz Sorensen, Nordborg (DK)

Correspondence Address: William M. Lee, Jr., Lee, Mann, Smith, MeWilliams, Sweeney & Ohlson, P.O. Box 2786, Chicago, IL, 60690-2786, US

(21) Appl. No.: 09/795,639

(22) Filed: Feb. 28, 2001

(30) Foreign Application Priority Data
Mar. 7, 2000 (DE) 100 11 017.7

(51) Int. Cl. B62D 5/06

(52) U.S. Cl. 180/441

(57) ABSTRACT

A hydraulic steering arrangement (1) having a steering valve (2) is described, by way of which steering valve (2) a steering motor is in communication with a pump and which steering valve (2) has a slider (3) having two end faces (8), which slider (3) can be displaced by a pressure fluid by means of a hydraulic steering unit (4) having a steering handwheel (5), the hydraulic steering unit (4) having two work connections (6) and each work connection (6) applying a work pressure to a respective end face of the two end faces (8) of the slider (3) by way of a connection (7).

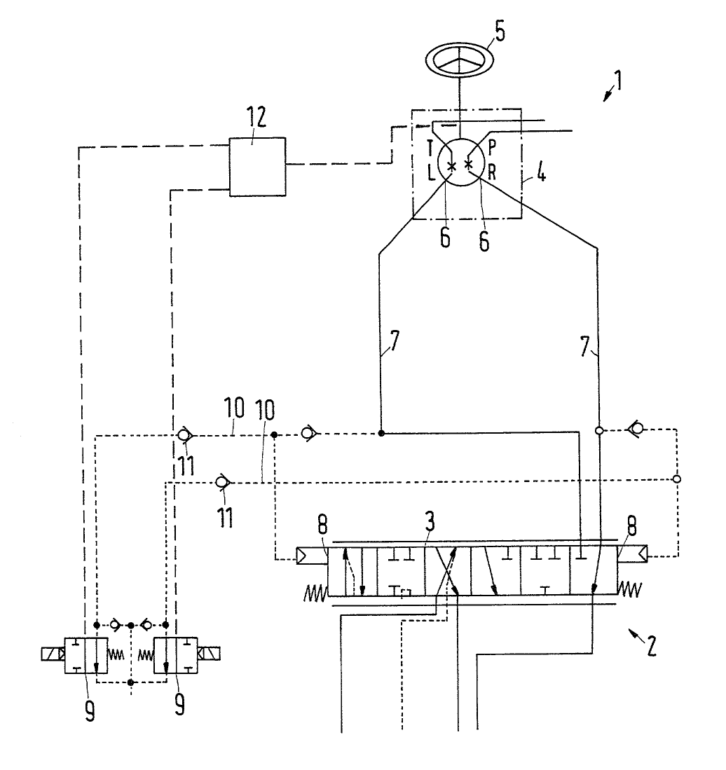

It is desired to be able to improve the steering comfort in a steering arrangement of that kind.

For that purpose, at least one of the work pressures at the end faces (8) of the slider (3) is additionally modifiable, on operation of the hydraulic steering unit (4), by means of an adjustable counter-pressure.

The invention relates to a hydraulic steering arrangement having a steering valve, by way of which steering valve a steering motor is in communication with a pump and which steering valve has a slider having two end faces, which slider can be displaced by a pressure fluid by means of a hydraulic steering unit having a steering handwheel, the hydraulic steering unit having two work connections and each work connection applying a work pressure to a respective end face of the two end faces of the slider by way of a connecting line.

A steering arrangement of that kind is known, for example, from the late-published German Patent Application 199 31 143.9, wherein the slider of the steering valve can be displaced either by pressures produced by the steering handwheel or by pressures produced by a control pressure generator. In the case of steering by means of the steering handwheel, the pressure difference between the end faces of the slider, and in consequence the reaction time of the steering arrangement, is, in all steering situations, nearly constantly proportional to the work pressures passed on by the hydraulic steering unit.

The problem underlying the invention is to improve the steering comfort.

In a hydraulic steering device of the kind mentioned at the beginning, the problem is solved according to the invention by means of the fact that at least one of the work pressures at the end faces of the slider is additionally modifiable, on operation of the hydraulic steering unit, by means of an adjustable counter-pressure.

The adjustable counter-pressures allow the resulting pressures at the end faces of the slider to be influenced. The latter pressures can accordingly be matched to various driving situations, depending upon whether a shorter or longer reaction time is useful for the person driving. As a result, the comfort and stability of vehicle control are improved.

It is advantageous if the work connections and the end faces of the slider are connected to a respective valve unit, the degree of opening of which can be modified. Accordingly, the level of the pressures that can be passed to the end faces of the slider by way of the work connections can be additionally controlled by means of the valve units.

It is also advantageous if the valve units can be operated, at least indirectly, by means of the steering handwheel. In cases where the valve units can be directly operated by means of the steering handwheel, operationally reliable and direct control is obtained, which in all cases gives the operator a secure feeling of control. Furthermore, an additional open-loop or closed-loop control unit between the hydraulic steering unit and the valve units is also possible, by means of which, for different situations, highly variable adjustments can be made to the counter-pressures, for example using a processor.

It is advantageous if the valve units are operable in dependence upon a rotary movement of the steering handwheel. As a result, the counter-pressures and, in consequence, the reaction time of the steering arrangement are set in dependence upon various rotary movements of the steering handwheel. The steering unit can accordingly be so adjusted that, in all situations, the operator has a secure feeling of control and the steering arrangement reacts in advantageous manner for the situation in question.

In an especially advantageous embodiment, the slower the steering handwheel is rotated, the greater is the degree of opening of the valve unit that is in communication with the pump connection. As a result of such a mode of operation of the valve units, a relatively low work pressure is present in the case of slow steering handwheel movements, resulting in a longer reaction time. In the case of rapid steering handwheel movements, the counter-pressure is high and accordingly the reaction time is relatively short. For the operator, both very stable slow control procedures and also very rapid steering movements, together with a short reaction time of the steering arrangement, become possible as a result.

In a further especially advantageous embodiment, the slower the steering handwheel is rotated, the lower is the degree of opening of the valve unit that is in communication with the tank connection. As a result thereof, when the steering handwheel is moved slowly, the work pressure, which acts against the movement of the slider, is kept relatively high, resulting in a longer reaction time. When the steering handwheel is moved rapidly, the degree of opening of the valve unit is, on the other hand, greater. As a result, the slider can be displaced more rapidly, which shortens the reaction time.

It is advantageous if each connecting line between the work connections and the end faces of the slider is connected to a valve unit by way of a control connection. That arrangement of the valve units in a subsidiary path of the connecting lines between the work connections and the end faces ensures that the control capability remains preserved even after intentional or unintentional closure of the valve units.

Is is also advantageous if the valve units are in the form of solenoid valves, which, as a result of their simple construction, ensure high operational reliability and are inexpensive.

It is also advantageous if each of the control connections has a non-return valve. On the one hand, these prevent the pressure fluid from flowing back and, on the other hand, they prevent pressure surges from being propagated into the connecting lines between the work connections of the hydraulic steering unit and the end faces of the sliders. Such pressure surges may arise in consequence of a rapid reduction in the degree of opening of the valve units. The non-return valves accordingly reduce malfunctions and potential damage to the steering arrangement.

The invention is described below in greater detail with reference to a preferred embodiment in conjunction with the drawing, wherein:

the single Figure shows, in diagrammatic form, a view of a hydraulic steering arrangement.

A hydraulic steering arrangement 1 has a steering handwheel 5, which is connected to a hydraulic steering unit 4. The hydraulic steering unit 4 is a conventional steering unit having two sliders that are rotatable relative to one another. The steering handwheel in that arrangement rotates one of the two sliders and, as a result, frees a path from a pump connection P to one of the work connections 6 (L, R) while the other work connection 6 (R, L) is connected to a tank connection T.

The hydraulic steering arrangement also has a steering valve 2, which includes a slider 3. The outlet of the steering valve 2 is connected to a steering motor, which turns steered wheels of a vehicle (not shown in greater detail). The slider 3 has two end faces 8. Between those end faces 8 and the work connections 6 of the hydraulic steering unit there are arranged connecting lines 7. Each of those connecting lines 7 is connected to a valve unit 9 by way of a control connection 10. Each of the two control connections 10 has a non-return valve 11.

On operation of the steering handwheel 5, a work pressure is applied to one of the two work connections 6 by means of the pump connection P. That work pressure is passed, by way of the connecting line 7, to an end face 8 of the slider 3. The work pressure is also applied to one of the valve units 9 by way of the control connection 10. At the same time, the other work connection 6 is connected to a tank or some other pressure sink by way of the tank connection T. The control pressure corresponding thereto is applied both to the other end face 8 of the slider 3 and to the other valve unit 9.

The resulting work pressure applied to the end faces 8 of the slider 3 is reduced or increased according to the degree of opening of those valve units 9, the degree of opening of the valve units 9 being dependent upon the speed with which the steering handwheel 5 is moved. Control of the degree of opening of the valve units 9 therein is performed either directly by means of the steering handwheel 5 or by means of an additional open-loop or closed-loop control unit 12 arranged between the steering handwheel 5 and the valve units 9. The said speed can be detected by means of a steering handwheel sensor (not shown in greater detail), which is connected to the open-loop or closed-loop control unit 12.

When the steering handwheel 5 is moved slowly, the degree of opening of the valve unit 9 that is in communication with the pump connection P is increased. As a result, the work pressure in the connecting line 7 between the hydraulic steering unit 4 and the end face 8 of the slider 3 is reduced. Also, the degree of opening of the valve unit 9 that is in communication with the tank connection T is reduced. The reaction time of the steering arrangement is increased as a result. The hydraulic steering arrangement 1 therefore reacts less sensitively when the steering handwheel 5 is being moved slowly, which leads to greater stability of control.

When the steering handwheel 5 is moved rapidly, the degree of opening of the valve unit 9 that is in communication with the pump connection P is reduced. When the rotary movement of the steering handwheel 5 is very rapid, the valve unit 9 that is in communication with the pump connection P can even close completely. In that case, the end face 8 of the slider 3 is acted upon by the full work pressure passed to the connecting line 7 from the pump connection P by way of the hydraulic steering unit 4. One end face 8 is accordingly acted upon by the maximum possible work pressure. At the same time, the degree of opening of the valve unit 9 that is in communication with the tank connection T is increased. As a result, the slider 3 can be moved very rapidly. The hydraulic steering arrangement 1 then has a short reaction time. In the case of rapid rotary movement of the steering handwheel 5, the steering of the vehicle will, accordingly, also react very rapidly.

The additional open-loop or closed-loop control unit 12 can be a purely mechanical device. An electronic open-loop or closed-loop control 12, for example operating with a processor, would also be possible, however.

1. Hydraulic steering arrangement having a steering valve (2), by way of which steering valve (2) a steering motor is in communication with a pump and which steering valve (2) has a slider (3) having two end faces (8), which slider (3) is arranged to be displaced by a pressure fluid by means of a hydraulic steering unit (4) having a steering handwheel (5), the hydraulic steering unit (4) having two work connections (6) and each work connection applying a work pressure to a respective end face of the two end faces (8) of the slider (3) by way of a connecting line (7), characterized in that at least one of the work pressures at the end faces (8) of the slider (3) is additionally arranged to be modified by means of an adjustable counter-pressure.

2. Steering arrangement according to claim 1, characterized in that the work connections (6) and the end faces (8) of the slider (3) are connected to a respective valve unit (9), the degree of opening of which is arranged to be modified.

3. Steering arrangement according to claim 1 or 2, characterized in that the valve units (9) are operable, at least indirectly, by means of the steering handwheel (5).

4. Steering arrangement according to any one of claims 1 to 3, characterized in that the valve units (9) are operable in dependence upon a rotary movement of the steering handwheel (5).

5. Steering arrangement according to any one of claims 1 to 4, characterized in that the slower the steering handwheel (5) is rotated, the greater is the degree of opening of the valve unit (9) which is in communication with the pump connection.

6. Steering arrangement according to any one of claims 1 to 4, characterized in that the slower the steering handwheel is rotated, the lower is the degree of opening of the valve unit which is in communication with the tank connection.

7. Steering arrangement according to any one of claims 1 to 6, characterized in that each connecting line (7) between the work connections (6) and the end faces (8) of the slider (3) is connected to a valve unit (9) by way of a control connection (10).

8. Steering arrangement according to any one of claims 1 to 7, characterized in that the valve units (9) are in the form of solenoid valves.

9. Steering arrangement according to any one of claims 1 to 8, characterized in that each of the control connections (10) has a non-return valve (11).
